(19) United States
(12) Patent Application Publication
(10) Pub. No.: US 2023/0314792 A1
(43) Pub. Date: Oct. 5, 2023

(54) Light Shield for MEMS Scanner

(71) Applicant: Microsoft Technology Licensing, LLC, Redmond, WA (US)

(72) Inventors: Di SUN, Bothel, WA (US); Xiao Chuan ONG, Bellevue, WA (US); Matthew David ELLIS, Sammamish, WA (US); Wyatt Owen DAVIS, Bothell, WA (US)

(21) Appl. No.: 17/711,639

(22) Filed: Apr. 1, 2022

(51) Int. Cl. G02B 26/08; G02B 26/10; B05D 1/32; B05D 1/02

(52) U.S. Cl. CPC G02B 26/0858; B05D 1/02; B05D 1/32; G02B 26/10

(57) ABSTRACT

A device includes a mirror coupled via a pair of flexible beams supported by a block of semiconductor material that has a cavity about the mirror and beams to allow the mirror to rotate about an axis along the beams. A piezoresistive sensor is coupled to one of the beams to provide information representative of an angle of rotation of the mirror. A light blocking shield covers exposed portions of the block of semiconductor material about the mirror.

### BACKGROUND

Small oscillating mirrors may be used to reflect laser generated light for head mounted displays. The mirrors may be formed from blocks of semiconductor material, essentially removing material from the block around and underneath the mirror and at the same time around a pair of flexible arms that allow the mirror to oscillate around a lengthwise axis of the arms. One or more piezoresistive sensors are used to sense the oscillation amplitude, frequency and phase, provide feedback to a controller and ensure oscillation continues at a desired frequency and amplitude. Light directed toward the mirrors can generate noise in the block of semiconductor material which can adversely affect the accuracy of sensor signals used to control oscillation of the mirror, leading to poor display of information on the head mounted display.

### SUMMARY

A device includes a mirror coupled via a pair of flexible beams supported by a block of semiconductor material that has a cavity about the mirror and beams to allow the mirror to rotate about an axis along the beams. A piezoresistive sensor is coupled to one of the beams to provide information representative of an angle of rotation of the mirror. A light blocking shield covers exposed portions of the block of semiconductor material about the mirror.

### BRIEF DESCRIPTION OF THE DRAWINGS

FIG. 1 is a block perspective diagram of a scanning device having light blocking shields according to an example embodiment.

FIG. 2 is a top view block representation of a scanning device prior to application of light blocking portions according to an example embodiment.

FIGS. 3A and 3B are a block flow diagram illustrating a method of forming a shield for a scanning device according to an example embodiment.

FIG. 4A is a block diagram of a system 400 that includes a side view cross section of the scanning device taken along lines 4A-4A of FIG. 2 according to an example embodiment.

FIG. 4B is a block diagram of the system 400 that includes a side view cross section of the scanning device taken along lines 4B-4B of FIG. 2 according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. Drawings are not necessarily to scale in order to conveniently illustrate features. The following description of example embodiments is, therefore, not to be taken in a limited sense, and the scope of the present invention is defined by the appended claims.

Piezoresistive sensors made from doped bulk silicon (Si) material have been widely used as a strain gauges due to its high piezoresistive coefficient in response to strain (gauge factor). Piezo resistors have been adopted in the laser MEMS scanners to measure the mechanical stress on a cantilever beam to provide feedback signal of an angle of a mirror supported by the beam as it oscillates in a rotating manner about an axis along the beam. Piezo resistors may be directly fabricated on a laser MEMS (micro-electromechanical systems) scanner device layer surface, which may be silicon in one example. The silicon may be intrinsic or doped. Silicon is an elastic material with low material losses, has very high strength, and can be easily micromachined.

While laser light hits the mirror, the adjacent silicon surface will also be exposed to laser light at the same time. Due to the semiconducting nature of the device layer, laser energy hitting on top of the silicon surface will generate electron hole pairs if the photon energy of the light exceeds the bandgap of the semiconductor material. For silicon, this is true even for visible light. The electron hole pairs result in light induced noise. The noise, which includes spikes of noise that can be coupled into the piezoresistor sensor signals. The noise is correlated with the sensor signals and can cause inaccurate MEMS scanning mirror rotating angle readout by adversely affecting the signal-to-noise ratio of the piezoresistive sensor.

Spikes of noise at that same frequency make electronic filtering of the noise difficult. While molded plastic covers may be used to block some light, such covers include an opening large enough for the mirror to reflect light at a large range of angles. The opening also allows hit silicon surface areas near the mirror.

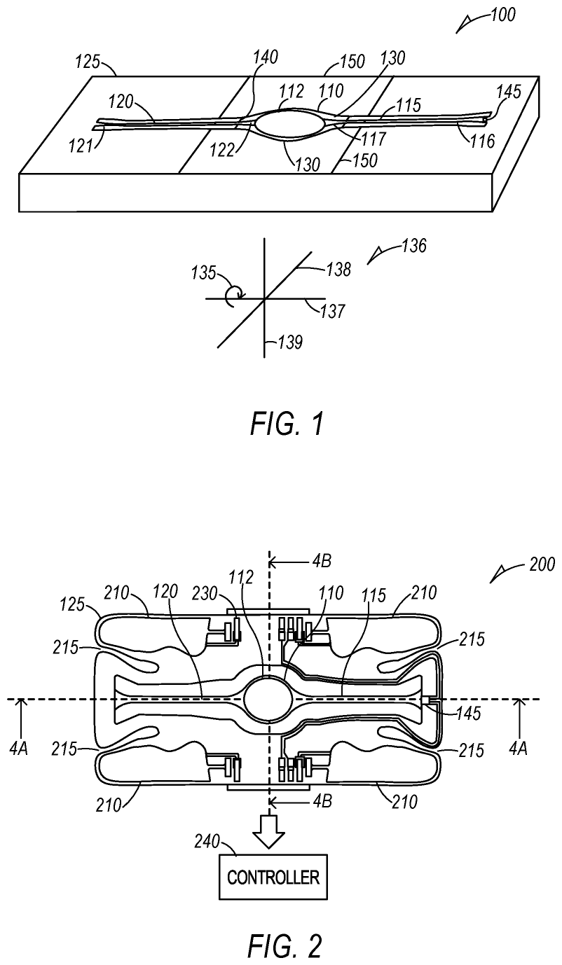

FIG. 1 is a block perspective diagram of a scanning device 100 that operates as a MEMS scanning mirror for a display system. Scanning device 100 may include a mirror platform 110 that includes a reflective mirror 112 formed on a top surface of the mirror platform. The mirror 112 may be formed of aluminum in one example, such as 100 nm thick Al, deposited or otherwise attached to the mirror platform 110. A pair of flexible arms or torsional flexure beams 115 and 120 have first ends 116 and 121 respectively coupled to a block 125 of semiconductor material and extend laterally towards each other in a cantilevered manner. In one example, the beams may be formed about 30 um-500 um thick.

The mirror platform 110 has two ends that are rotatingly coupled to respective seconds ends 117 and 122 of the flexible beams 115 and 120. The beams and mirror platform may be formed from the block 125 and are disposed within a cavity 130 that allows the mirror platform 110 to rotate near its resonant frequency about a lengthwise axis extending through the mirror platform and between the first and second ends of the beams 115 and 120. The direction of rotation is represented by arrow 135 in a coordinate system representation 136. The direction of the lengthwise axis is represented at 137, width at 138, and depth at 139.

The cavity 130 is formed in one example by etching or otherwise removing material in the block 125 of material about the mirror platform and beams with a depth, width, and length sufficient to allow the mirror platform to rotate about the lengthwise axis along the beams. Cavity 130 may have sidewalls, such as sidewall 140 that extends from the top surface of the block 125 to a bottom of the cavity 130. The formation of the cavity 130 may be done in a conventional manner such as by deep reactive ion etching (DRIE) of the block 125 and a handle layer attached to the block 125 to form the beams 115, 120 and mirror platform 110 followed by a box layer release. The block 125 may be supported by a ceramic substrate in one example to provide structural support.

A piezoresistive sensor 145 is coupled near the second end of beam 115 in a manner that causes a change in resistance in response to mechanical stress or strain in the tensor arm 115 representative of a rotation angle of the oscillating mirror platform 110. The piezoresistive sensor 145 may be formed by doping the block 125 material to form a piezoresistor and may be used to generate electrical signals representative of mirror platform 110 oscillation amplitude, frequency, and phase. In one example, the block 125 may be doped to be p-type whereas the sensor is doped to be n-type to generate an electric field across a p-n junction where the two types meet. When electrons and holes generated by light hitting the silicon surface of the block 125 arrive at the p-n junction by diffusion, the electric field across the p-n junction separates the electrons from the holes, generating a photocurrent, which is noise. The carrier density in the piezoresistor is also increased, which modulates the resistance of the piezoresistor. Since in most display systems, the light impinging on mirror is synchronized with the mirror motion, the noise in the piezoresistor is strongly correlated with the light impinging onto the mirror. In display systems, where the content being displayed determines the light impinging on the mirror, this results in errors in the control of the mirror that are dependent on the content being displayed. Such correlated noise is also difficult to remove by conventional signal processing techniques.

Any other type of sensor capable of providing information representative of the angle of the mirror platform 110 may be used in further examples. Multiple sensors may be used on one or more beams in further examples.

Scanner 100 in one example is used to reflect light from multiple lasers onto a display screen for displaying information. Two scanners may be used in one example. One scanner may be used to reflect the light in a vertical direction with respect to the display screen and another scanner may be used to direct light in a horizontal direction. The lasers may direct red, green, and blue light pulses that are timed to be reflected to precise areas corresponding to pixels at the right times. The timing of the pulses is controlled to form an accurate representation of the information to be displayed in a common manner. The accuracy of the timing and hence location of the light on the display screen is dependent on the measured angle of the mirror 112 on the mirror platform 110.

The light from the lasers may not only impinge on the mirror 112 of the mirror platform 110. Some of the light may fall on portions of the semiconductor block 125 that are near the mirror 112. The light may produce electron-hole pairs in the portions of the semiconductor block. Such electron-hole pairs can result in noise in the information provided by the sensor 145 which is electrically coupled to the semiconductor block. The noise can result in increased jitter, making control of the oscillation in a closed loop configuration more difficult.

To reduce the production of such noise, a light blocking material 150 may be used to cover the portions of the semiconductor block that are likely to be exposed to light from the lasers in order to protect exposed portions of the block of material about the mirror platform to reduce production of electron-hole pairs in response to light directed toward the mirror 112. Two portions of light blocking material 150 are shown, one on either side of the mirror platform 110.

The light blocking material 150, also referred to as a shield or shields, in one example is non-conductive and extends to or near to an edge of the opening 130 on both sides of the opening 130 to optimize blocking of light from impinging on the block 125. In one example, the shield may be formed of plastic and adhered to the block 125. An opaque epoxy may be applied to the block 125 and may alternatively serve as blocking material 150. The term, opaque, may be any material that block or substantially blocks like in the visible spectrum in one example corresponding to red, green, and blue laser light used for display technologies. In some examples, multiple layers of opaque material may be used to obtain sufficient light blocking capability. In further examples, infrared frequencies may also be blocked.

The portions of light blocking material 150 extend in one example at least for the full length of the mirror platform and beyond at least to an extent that protects enough of the semiconductor block 125 from being exposed to light of a power that would adversely introduce noise in sensor information that would make it difficult to derive the correct mirror angle from the sensed information to produce images of desired quality. The overall length of the shield can vary depending on the dimensions of the mirror platform and the configuration and specifications of the laser light. A desired length and width may be determined empirically via testing different sizes of light blocking material 150. The width of the blocking material may extend the entire width of the block 125 in one example. In further examples, the light blocking material covers enough of the blocking material that light impinging on the uncovered areas is not enough to degrade operation of the sensor that determining the angle correctly from the sensed information becomes problematic.

In one example, the mirror 112 extends an entire width of the mirror platform. The mirror platform 110 and beams 115 and 120 are formed from the semiconductor block. As such, exposed areas of the platform and tensor arms may also generate electron-hole pairs. In one example, the amount of area of the mirror platform exposed is small enough that minimal numbers of electron-hole pairs are generated by light hitting such exposed areas. It may also be desired not to modify the mass of the mirror platform 110 and beams 115 and 120 with light blocking material so as to maintain a desired resonant frequency of oscillation of the mirror platform, mirror and tensor arms.

In one example, the light blocking material 150 may be a light shield that substantially blocks light from reaching the block 125. The light blocking material 150 may be adhered to the block 125 via adhesive and may extend a desired distance into the cavity, creating an overhang to reduce light striking the sidewalls 140. In a further example, light blocking material 150 may be an opaque or substantially opaque epoxy or glue that may be supported by the block 125. The light blocking material is applied in portions of the block 125 that do not mechanically move during operation to reduce mechanical impact on the resonant frequency.

In one example, the piezoresistive sensor 145 may also be covered with the light blocking material. As the sensor 145 is formed near or proximate to the near the second end of a beam which does not move much in response to mirror oscillation, light blocking material formed over the sensor 145 does not significantly affect the resonant frequency. The light blocking material may also be sprayed with the use of a suitable mask as described in further detail below.

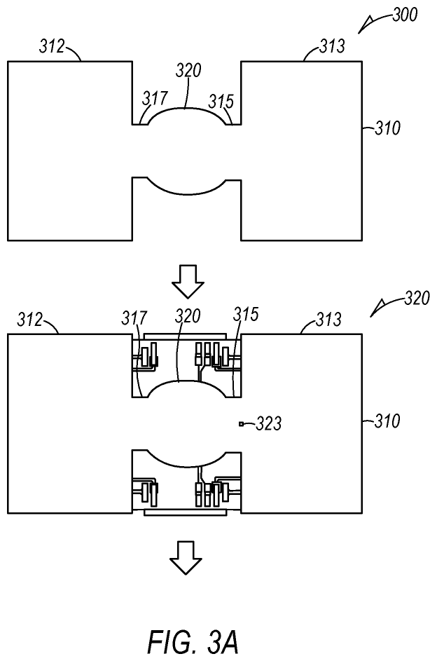

FIG. 2 is a top view block representation of a scanning device 200 prior to application of light blocking portions. This figure is provided to better show how control of the oscillation is performed and does not illustrate the use of shields. Like elements are identified with the same reference numbers as like elements of FIG. 1.

Components used to actuate the mirror support 110 are illustrated. In one example, piezoelectric actuators 210 are formed about the second ends of the beams 115 and 120. The actuators 210 are supported by the block 125. Openings 215 are formed between the actuators 210 and the beams 115 and 120. Contact pads 230 are formed and connected to the actuators 210 and sensor 145 via multiple conductors. The contact pads and conductors may be formed using known metallization processes. The contact pads 230 are also coupled to a controller 240. Controller 240 receives sensor signals and controls the actuators to deform in a manner to maintain oscillation at a desired frequency and amplitude. Such control is performed in a closed loop manner. Removing jitter caused by generation of electron-hole pairs in the block 125 can help the controller better control the frequency of oscillation of the mirror support 110, ensuring the reflected laser light reaches desired points or pixels of the display at desired times.

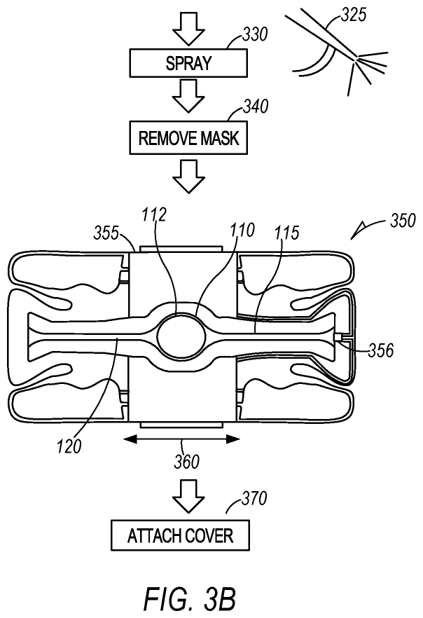

FIGS. 3A and 3B are a block flow diagram illustrating a method 300 of forming a shield. The shield is used to keep silicon surface insulated from the laser and suppress the light sensitivity of piezo resistors at the flexure beam. In a further example, a spray coating method may be used to cover the exposed surfaces of the block 125 around the mirror 112 and mirror support 110.

Method 300 includes fabricating the shield by fabricating a stencil mask 310. The stencil mask 310 may be cut from a piece of metal in one example, such as by laser, or may be a silicon pad or other material suitable for masking. The stencil mask 310 may also be formed using a lithography patterning process and etched by plasma or wet chemicals. Mask 310 includes two larger rectangular portions 312 and 313 that are connected by respective narrow portions 315 and 317 and a mirror support shaped portion 320 connecting the narrow portions 315 and 317. In one example, the narrow portions are designed to match or slightly overlap the beams 115 and 120 and the mirror support shaped portion 320 is designed to match or slightly overlap the mirror support 110.

At 322, the mask 310 is placed on top of block 125, the mirror and 112, and at least a portion of the tensor arm surfaces as shown at 322. The mask is aligned to substantially cover portions of the arms and mirror support that are likely to be exposed to light during use as a scanner. The narrow portions 315 and 317 may overlap the beams 115 and 120 a desired amount to prevent spray from coating the surface of and sides of the arms. Similarly, the mirror support shaped portion 320 is also overlap the surface and sides of the mirror support 320 a desired amount to prevent spray from coating the surface and sides of the mirror support 320. In one example, a further opening 232 in the mask 310 may be formed to align with the sensor such that the sensor is also coated.

Using an aerosol spray, air brush, or spray coater 325, non-conductive opaque material is sprayed at 330 on top of the exposed silicon area, and dried to form a shield. Multiple layers of material may be applied to achieve desired light blocking characteristics of the shield. The spray can be vertical to the block 125 surface or at one or more angles sufficient to coat sidewalls 140 of the block 125 with minimal if any coverage of the sides of the beams and mirror support. The opaque material may be black paint that may contain carbon nanotubes or black enamel. Any other substantially opaque non-conductive material may be used in various examples that provide sufficient blockage of light to minimize electron hole generation may be used. The use of a non-conductive material may be used if contact pads 230 or conductors will be covered by the shield. In one example, the opaque material may be removed from the contact pads 230 and conductors, or the mask may be modified to cover such contacts and conductors such that they are not covered by the sprayed material. The contact pads 230 may be wire bond pads for connecting to other devices.

Following spraying 330, the stencil mask 310 may be removed by lifting it off at 340. As seen at 350, the resulting shield is indicated at 355 in two portions on either side of the mirror 112 and optionally a shield 356 to cover the sensor. The coverage is sufficient to prevent the generation of electron-hole pairs via light interaction with the block 125. Arrow 360 shows one example of the length of the shield 355 which extends laterally beyond the mirror a desired amount. A protected molded cover may be attached at 370 to protect the scanner device 100. The cover may have an aperture to allow laser light to reach the mirror. The cover may also be opaque and may help protect areas of the block 125 not covered by a shield. The size of the aperture in the cover can also be used to help decide how much of the block 125 to cover with shield material. The opening needs to be large enough to allow light to be reflected by the mirror 112. Manufacturing tolerances of the opening may be considered in determining how far to extend the coverage of the shield or shields.

The method 300 using a spray coating process is compatible with mass semiconductor production processes. In addition to top surfaces, sidewalls 140 of the exposed block 125 may also be coated, providing three-dimensional coverage of the exposed semiconductor material regions. The sprayed shield can also be very thin but should be thick enough to block light that might interfere with determining the angle of the mirror. The resonant frequency and drive power of the laser MEMS scanning mirror won't change after spraying and removing the mask.

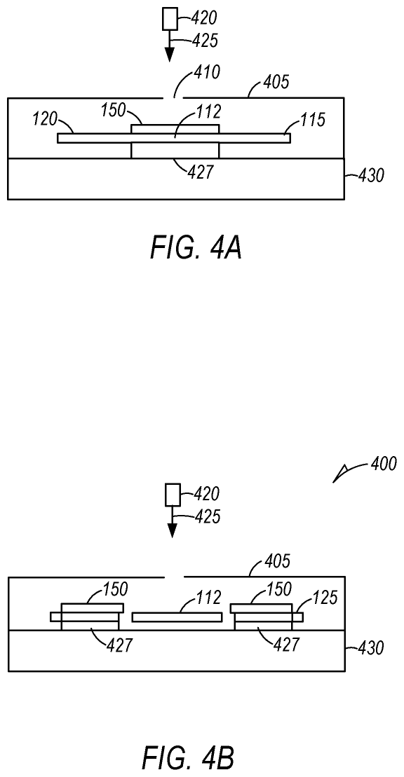

FIG. 4A is a block diagram of a scanning system 400 that includes a side view cross section of scanning device 200 taken along lines 4A-4A of FIG. 2 supported on a substrate 430 via pads 427. FIG. 4B is a block diagram of the system 400 that includes a side view cross section of scanning device 200 taken along lines 4B-4B of FIG. 2. The beams 115 and 120 are shown cantilevered across the cavity 130. The mirror support 110 and mirror 112 are shown supported by the beams 115 and 120 in the cavity. A cover 405 is coupled to the block 125 to provide protection. The cover 405 has an opening 410 that is large enough to allow lasers 420 to direct laser light 425 toward the mirror 112. As shown, the light blocking material 150 has been added to the scanning device 200 and extends laterally beyond edges of the opening 410 to prevent light from impinging on the block 125. Light blocking material 150 is also shown overhanging the cavity. Block 125 is supported by the two pads 427 to the substrate 430. As seen in FIG. 4, the cavity may extend all the way through the block 130 to the substrate 430, which may be non-conductive material, such as a ceramic material. The pads 427 support the block 125 above the substrate 430, allowing for rotation of the mirror 112.

### EXAMPLES

1. A device includes a mirror coupled via a pair of flexible beams supported by a block of semiconductor material that has a cavity about the mirror and beams to allow the mirror to rotate about an axis along the beams, a piezoresistive sensor coupled to one of the beams to provide information representative of an angle of rotation of the mirror, and a light blocking shield covering exposed portions of the block of semiconductor material about the mirror.

2. The device of example 1 wherein the mirror is formed on a mirror platform coupled to the beams and wherein the mirror platform and beams are formed from the block of semiconductor material.

3. The device of example 2 wherein the semiconductor block comprises doped silicon.

4. The device of any of examples 1-3 wherein the light blocking shield is nonconductive.

5. The device of any of examples 1-4 wherein the light blocking shield extends outward from edges of the cavity and overhangs the cavity.

6. The device of any of examples 1-5 wherein the light blocking shield is positioned to reduce production of electron-hole pairs in response to light directed toward the mirror.

7. The device of any of examples 1-6 wherein the light blocking shield comprises an opaque material that is adhered to the block.

8. The device of any of examples 1-4 wherein the light blocking shield comprises an opaque material sprayed on the exposed portions of the block through a mask.

9. The device of example 8 wherein sidewalls of the cavity are coated with the opaque material.

10. The device of example 9 wherein the light blocking material comprises black paint with carbon nanotubes.

11. The device of any of examples 1-10 wherein the mirror rotates within a range of angles sufficient to direct red, green, and blue laser light toward a display screen of a head mounted display device.

12. A system includes a block of doped semiconductor material having a cavity formed in the block, a pair of flexible beams formed from the block and each coupled at first ends to the block and extending laterally towards each other in the cavity, a mirror support formed from the block and rotatingly coupled between second ends of the beams in the cavity, a mirror coupled to the mirror support, a piezoresistive sensor coupled to one of the beams to provide information representative of an angle of rotation of a mirror coupled to the mirror support as a function of strain induced in the one of the beams by such rotation, and an electrically nonconductive light blocking shield coupled to portions of the block of material about the mirror to reduce production of electron-hole pairs in response to light directed toward the mirror.

13. The system of example 12 wherein the light blocking shield comprises an opaque material that is adhered to the block and sidewalls of the cavity, and wherein the light blocking material comprises black paint with carbon nanotubes.

14. A method includes applying a mask to cover a mirror platform and selected portions of a pair of flexible beams supported by a semiconductor block of material, wherein the mirror platform is supported by the beams in a cavity in the block of material to allow the mirror platform to rotate about an axis along the beams, applying a light blocking material to uncovered areas of the block of material to protect exposed portions of the block of material about the cavity to reduce production of electron-hole pairs in response to light directed toward the mirror platform, and removing the mask.

15. The method of example 14 wherein the light blocking material is nonconductive to electricity.

16. The method of any of examples 14-15 wherein the light blocking material is sprayed onto the uncovered areas of the block including sidewalls of the cavity.

17. The method of any of examples 14-16 wherein the light blocking material comprises black paint with carbon nanotubes.

18. The method of any of examples 14-17 wherein the mask covers a mirror supported on the mirror platform, and wherein the mirror platform and beams are formed from the block of doped silicon semiconductor material.

19. The method of any of examples 14-18 wherein the mask extends beyond mirror platform and beams to prevent light blocking material from being applied to sides of the mirror platform and beams.

20. The method of any of examples 14-19 wherein the mask is shaped to allow application of light blocking material to areas of the semiconductor block that are likely to be exposed to light directed toward the mirror platform.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device comprising:
a mirror coupled via a pair of flexible beams supported by a block of semiconductor material that has a cavity about the mirror and beams to allow the mirror to rotate about an axis along the beams;
a piezoresistive sensor coupled to one of the beams to provide information representative of an angle of rotation of the mirror; and
a light blocking shield covering exposed portions of the block of semiconductor material about the mirror.

2. The device of claim 1 wherein the mirror is formed on a mirror platform coupled to the beams and wherein the mirror platform and beams are formed from the block of semiconductor material.

3. The device of claim 2 wherein the semiconductor block comprises doped silicon.

4. The device of claim 1 wherein the light blocking shield is nonconductive.

5. The device of claim 1 wherein the light blocking shield extends outward from edges of the cavity and overhangs the cavity.

6. The device of claim 1 wherein the light blocking shield is positioned to reduce production of electron-hole pairs in response to light directed toward the mirror.

7. The device of claim 1 wherein the light blocking shield comprises an opaque material that is adhered to the block.

8. The device of claim 1 wherein the light blocking shield comprises an opaque material sprayed on the exposed portions of the block through a mask.

9. The device of claim 8 wherein sidewalls of the cavity are coated with the opaque material.

10. The device of claim 9 wherein the light blocking material comprises black paint with carbon nanotubes.

11. The device of claim 1 wherein the mirror rotates within a range of angles sufficient to direct red, green, and blue laser light toward a display screen of a head mounted display device.

12. A system comprising:
a block of doped semiconductor material having a cavity formed in the block;
a pair of flexible beams formed from the block and each coupled at first ends to the block and extending laterally towards each other in the cavity;
a mirror support formed from the block and rotatingly coupled between second ends of the beams in the cavity;
a mirror coupled to the mirror support;
a piezoresistive sensor coupled to one of the beams to provide information representative of an angle of rotation of a mirror coupled to the mirror support as a function of strain induced in the one of the beams by such rotation; and
an electrically nonconductive light blocking shield coupled to portions of the block of material about the mirror to reduce production of electron-hole pairs in response to light directed toward the mirror.

13. The system of claim 12 wherein the light blocking shield comprises an opaque material that is adhered to the block and sidewalls of the cavity, and wherein the light blocking material comprises black paint with carbon nanotubes.

14. A method comprising:
applying a mask to cover a mirror platform and selected portions of a pair of flexible beams supported by a semiconductor block of material, wherein the mirror platform is supported by the beams in a cavity in the block of material to allow the mirror platform to rotate about an axis along the beams;
applying a light blocking material to uncovered areas of the block of material to protect exposed portions of the block of material about the cavity to reduce production of electron-hole pairs in response to light directed toward the mirror platform; and
removing the mask.

15. The method of claim 14 wherein the light blocking material is nonconductive to electricity.

16. The method of claim 14 wherein the light blocking material is sprayed onto the uncovered areas of the block including sidewalls of the cavity.

17. The method of claim 14 wherein the light blocking material comprises black paint with carbon nanotubes.

18. The method of claim 14 wherein the mask covers a mirror supported on the mirror platform, and wherein the mirror platform and beams are formed from the block of doped silicon semiconductor material.

19. The method of claim 14 wherein the mask extends beyond mirror platform and beams to prevent light blocking material from being applied to sides of the mirror platform and beams.

20. The method of claim 14 wherein the mask is shaped to allow application of light blocking material to areas of the semiconductor block that are likely to be exposed to light directed toward the mirror platform.
